(19) United States
(12) Patent Application Publication
(10) Pub. No.: US 2012/0158650 A1
(43) Pub. Date: Jun. 21, 2012

(54) DISTRIBUTED DATA CACHE DATABASE ARCHITECTURE

(75) Inventors: Mihnea Andre, Issy les Moulineaux (FR); Yanhong Wang, San Ramon, CA (US); Rajkumar Sen, Pune (IN); Heping Shang, Walnut Creek, CA (US); Stephen Shepherd, Lakewood, CO (US); Jian Yang, San Ramon, CA (US); Peter John Dorfman, Belmont, MA (US); Johan Nicolaas Schukkink, Utrecht (NL); Xiao-Yun Wang, Vaucresson (FR); Teja Mupparti, San Ramon, CA (US); Andrew D. Scott, San Ramon, CA (US)

(73) Assignee: Sybase, Inc., Dublin, CA (US)

(21) Appl. No.: 13/091,303

(22) Filed: Apr. 21, 2011

Related U.S. Application Data
(60) Provisional application No. 61/423,987, filed on Dec. 16, 2010.

(51) Int. Cl. G06F 17/30

(52) U.S. Cl. 707/611; 707/802; 707/687; 707/613; 707/E17.005

(57) ABSTRACT

System, method, computer program product embodiments and combinations and sub-combinations thereof for a distributed data cache database architecture are provided. An embodiment includes providing a scalable distribution of in-memory database (IMDB) system nodes organized as one or more data fabrics. Further included is providing a plurality of data granularity types for storing data within the one or more data fabrics. Database executions are managed via the one or more data fabrics for a plurality of applications compatible with at least one data granularity type.

### CROSS-REFERENCE TO RELATED APPLICATIONS

The present application claims the benefit of U.S. Provisional Patent Application No. 61/423,987, filed on Dec. 16, 2010, entitled “Distributed Data Cache Database Architecture,” which is incorporated by reference herein in its entirety.

### BACKGROUND

1. Field

The present invention relates generally to databases, particularly to improving database performance and scalability with a distributed cache-based database system.

2. Background

The traditional outlook towards management of transactional business data is based on a persistent transaction data processing model: a debit from one account and a credit to another account once acknowledged to an end user must necessarily be reflected in the underlying accounts, even if the underlying computing system suffers an immediate outage at the point of transaction completion. When the system comes up, the debit account as well as the credit account must correctly reflect their state as they existed at the precise moment the transaction was successfully acknowledged to the end user. That is, these changes need to be durable.

Transaction processing data management systems are built around providing such guarantees. These OLTP (online transaction processing system) systems are designed around ACID properties: Atomic, Consistent, Isolated and Durable. These properties ensure that business transactions are fully reliable and accurately reflected in the underlying system, even when hundreds of transactions are processed simultaneously and under unpredictable system failure scenarios.

Traditionally, transactions are processed with databases stored using disk-based storage devices. However, disk access can be very slow. Thus, high-performance enterprise applications often encounter performance bottlenecks and scalability problems for transaction processing when trying to access data stored in a database. To improve database performance, main memory has been used as a data buffer or cache for data stored on disk. However, a need still exists for further improved performance and resolution of scalability issues, particularly for large enterprise applications, through development of a distributed caching system, which combines the scalability of distributed systems with the reduced access latency of main memory. The present invention addresses such needs.

### BRIEF SUMMARY

Briefly stated, the invention includes system, method, computer program product embodiments and combinations and sub-combinations thereof for a distributed data cache database architecture. An embodiment includes providing a scalable distribution of in-memory database (IMDB) system nodes organized as one or more data fabrics. Further included is providing a plurality of data granularity types for storing data within the one or more data fabrics. Database executions are managed via the one or more data fabrics for a plurality of applications compatible with at least one data granularity type.

Embodiments may be implemented using hardware, firmware, software, or a combination thereof and may be implemented in one or more computer systems or other processing systems.

Further embodiments, features, and advantages of the present invention, as well as the structure and operation of the various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments are described, by way of example only, with reference to the accompanying drawings. In the drawings, like reference numbers may indicate identical or functionally similar elements. The drawing in which an element first appears is typically indicated by the leftmost digit or digits in the corresponding reference number.

FIG. 1 is a diagram of an exemplary database system.

FIG. 2 is an architecture diagram of an exemplary data grid in a database environment, according to an embodiment.

FIG. 3 is a diagram illustrating a data fabric and backend of the data grid of FIG. 2, according to an embodiment.

FIG. 4 illustrates an exemplary database tree schema, according to an embodiment.

FIG. 5 is a diagram illustrating an example of splitting horizontal partitions from a set of tables across multiple nodes for a data fabric having table partition granularity, according to an embodiment.

FIG. 6 is a table illustrating an example of distributing ownership rights for multiple nodes based on round-robin slice teams, according to an embodiment.

FIG. 7 is a diagram of an example data grid with several fabrics, according to an embodiment.

FIG. 8 is a diagram of an example computer system in which embodiments can be implemented.

The accompanying drawings, which are incorporated herein and form part of the specification, illustrate the embodiments of present invention and, together with the description, further serve to explain the principles of the invention and to enable a person skilled in the relevant art(s) to make and use the invention.

### DETAILED DESCRIPTION

### Table of Contents

I. Database System

II. Data Grid

III. Example Computer System Implementation

IV. Conclusion

Embodiments relate to a distributed data cache database architecture. As will be described in further detail below, it is an ideal way to improve performance when processing critical transactions between a database server and one or more client applications.

While the present invention is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to effect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The term “in-memory database,” or “IMDB,” is used herein to refer broadly and inclusively to any database management system that primarily relies on main memory, rather than a disk-based mechanism, to store and manage data. In addition, such IMDBs typically reside entirely within main memory. A person skilled in the relevant art given this description would appreciate that IMDBs are generally faster than databases that rely on disks for storage.

### I. Database System

Databases commonly organize data in the form of tables. Each table generally has a number of rows and columns, and each row in a table generally has a data value associated with each of the columns. This intersection of rows and columns is commonly referred to as a cell. A system needing access to data in the database typically issues a request in the form of a query. A query usually involves a request for the data contained in one or more cells of any rows that meet a particular condition. This condition often involves the comparison of the values of cells in a column to some other value to determine whether the row associated with the compared cell meets the condition.

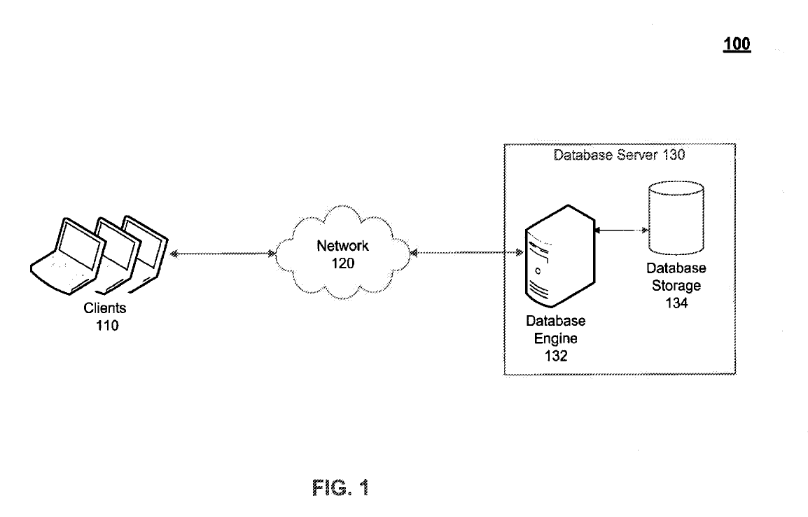

FIG. 1 is a diagram of an exemplary database system. Database system 100 includes one or more clients 110, a network 120, and a database server 130. The database server 130 includes a database engine 132 and database storage 134.

Clients 110 are operable to send requests for data, commonly in the form of a database queries, to database server 130 over network 120. Database server 130 replies to each request by sending a set of results, commonly in the form of result rows from a database table, to clients 110 over network 120. One skilled in the relevant art given this description will appreciate that any data format operable to convey a request for data and a reply to the request may be used. In accordance with an embodiment, the requests and replies are consistent with the conventions used in the Structured Query Language (“SQL”), although this example is provided solely for purposes of illustration and not limitation.

Clients 110 can each be any type of computing device having one or more processors, a user input (for example, a mouse, QWERTY keyboard, touch-screen, microphone, or a T9 keyboard), and a communications infrastructure capable of receiving and transmitting data over a network. For example, clients 110 can include, but are not limited to, a mobile phone, a personal digital assistant (FDA), a computer, a cluster of computers, a set-top box, or other similar type of device capable of processing instructions and receiving and transmitting data to and from humans and other computing devices.

Similarly, database server 130 may be implemented on any type of computing device. Such a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm.

Network 120 can be any network or combination of networks that can carry data communication. Such network can include, but is not limited to, a wired (e.g., Ethernet) or a wireless (e.g., Wi-Fi and 3G) network. In addition, network 120 can include, but is not limited to, a local area network, medium area network, and/or wide area network such as the Internet. Network 120 can support protocols and technology including, but not limited to, Internet or World Wide Web protocols and/or services. Intermediate network routers, gateways, or servers may be provided between components of database system 100 depending upon a particular application or environment.

When a request for data, such as a query, is received by database server 130, it is handled by database engine 132. Database engine 132 is operable to determine the data requested by the query, obtain the data, and provide a reply to the query. One skilled in the relevant art given this description will appreciate that while database engine 132 is illustrated as a single module in database system 100, database engine 132 may be implemented in a number of ways in order to accomplish the same function. Accordingly, the illustration of modules in database server 130 is not a limitation on the implementation of database server 130.

Database engine 132 is operable to obtain the data in response to the query from database storage 134. Database storage 134 stores values of a database in a data structure. Typically, database values are stored in a table data structure, the table having data rows and columns. At the intersection of each row and column is a data cell, the data cell having access to a data value corresponding to the associated row and column. Each column normally has an associated data type, such as “string” or “integer,” which is used by database engine 132 and clients 110 to interpret data contained in a data cell corresponding to the column. The database often comprises multiple tables.

Additionally, database storage 134 comprises alternate means of indexing data stored in a table of a database. Database engine 132 is operable to analyze a query to determine whether an available alternate means is useful to better access the data stored in a table, and then utilizes this alternate means to obtain data from the table.

Further, database storage 134 may be implemented as a relational database and database engine 132 may be implemented using a relational database management system (RDBMS). An example of such a RDBMS is, for example and without limitation, Adaptive Server Enterprise (ASE) from Sybase, Inc. of Dublin, Calif. A person skilled in the relevant art given this description would appreciate that embodiments may be operable to work with any RDBMS.

### II. Data Grid

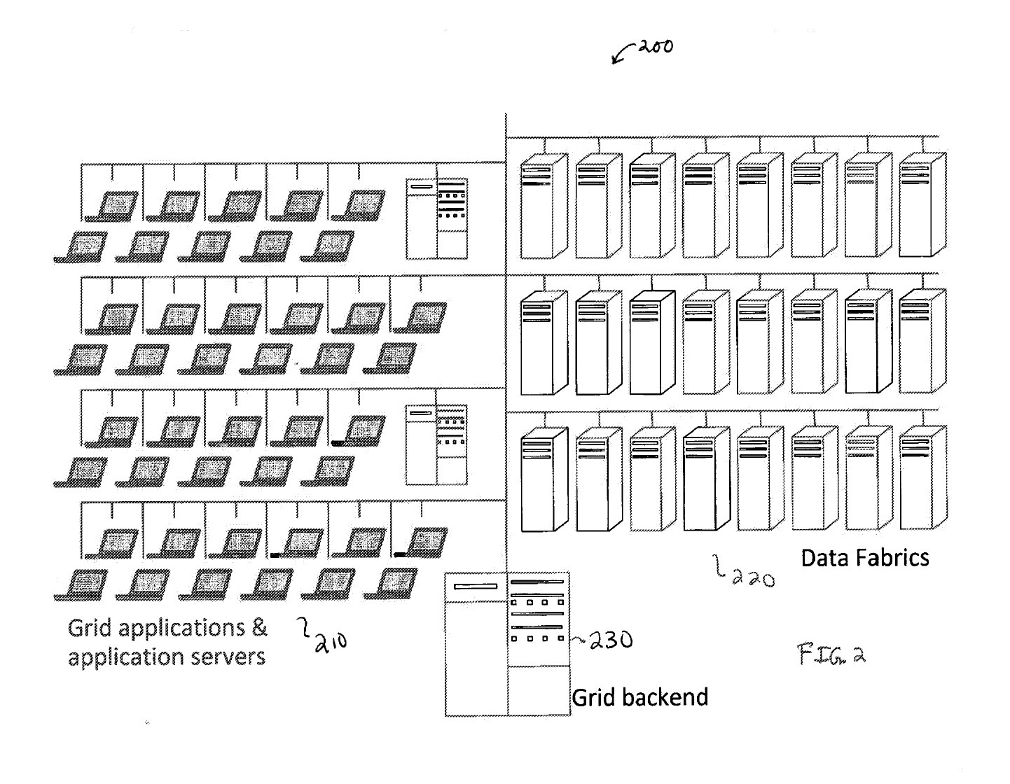

FIG. 2 is an architecture diagram of an exemplary data grid 200 in a database environment, according to an embodiment of the present invention. The use of a data grid as described herein is intended to provide improved performance and scalability through the interaction of several mechanisms. A key mechanism is a set of clustered cache nodes, linking clients to database servers in a data fabric configuration.

Data grid 200 includes grid applications 210, data fabrics 220, and a grid backend 230, according to an embodiment. Although multiple data fabrics 220 are shown, data grid 200 can have a single data fabric. In an embodiment, each data fabric (e.g., data fabric 220) within data grid 200 is a clustered memory cache comprising multiple cache nodes, which are configured to store all or portions of data in a database system.

For ease of explanation, data grid 200 will be described in the context of database system 100 of FIG. 1, but is not intended to be limited thereto. In an embodiment, the various components of data grid 200, including grid applications 210, data fabric 220, and grid backend 230, are communicatively coupled to each other via, for example, a network (e.g., network 120 of FIG. 1).

In an embodiment, data grid 200 comprises an architecture built around a distributed in-memory database (IMDB) cache that is clustered on multiple physical machines. Such a clustered IMDB cache provides a responsive transaction-performance model for processing query transactions to and from client applications (e.g., executed by clients 110 of FIG. 1) and a database server (e.g., database server 130 of FIG. 1). As will be described in further detail below, the clustered IMDB cache of data grid 200 allows for scale-out on multiple database servers. It should be noted that data grid 200 is not simply a mid-tier cache between client applications 210 and grid backend 230. Thus, in contrast to conventional caching systems, data grid 200 can continue to seamlessly process transactions even in the absence of grid backend 230, as described in further detail below.

In an embodiment, grid applications 210 may be any type of client application that connects to any of the cache nodes of data fabric 220 for purposes of optimizing transaction performance and/or scale-out. For example, grid applications 210 may be one or more time-sensitive enterprise client applications that require reduced access latency and fast query response times. Grid applications 210 may be hosted, for example, on one or more computing devices, for example, clients 110 of FIG. 1. In an embodiment, grid applications 210 send transaction queries to data grid 200 over a network, for example, network 120 of FIG. 1. Grid applications 210 can be implemented in software, firmware, hardware, or a combination thereof. Further, grid applications 210 can also be implemented as computer-readable code executed on one or more computing devices capable of carrying out the functionality described herein. As noted above, examples of computing devices include, but are not limited to, clients 110 of FIG. 1.

In an embodiment, grid backend 230 is an enterprise-class relational database and relational database management system (RDBMS). As noted above, an example of such a RDBMS is, for example and without limitation, Adaptive Server Enterprise (ASE) from Sybase, Inc. of Dublin, Calif. Grid backend 230 may be implemented using, for example, database server 130 of FIG. 1.

In an embodiment, data grid 200 comprises an architecture built around a distributed in-memory database (IMDB) cache that is clustered on multiple physical machines. Such a clustered IMDB cache provides a responsive transaction-performance model for processing query transactions to and from client applications (e.g., executed by clients 110 of FIG. 1) and a database server (e.g., database server 130 of FIG. 1). As will be described in further detail below, the clustered MDB cache of data grid 200 allows for scale-out on multiple database servers. Such database servers can be implemented using any computing device having at least one processor and at least one memory device for executing and storing instructions. Such a memory device may be any type of recording medium coupled to an integrated circuit that controls access to the recording medium. The recording medium can be, for example and without limitation, a semiconductor memory such as random-access memory (RAM), high-speed non-volatile memory, or other similar type of memory or storage device. Further, cache nodes of data fabric 220 may be communicatively coupled to each other and one or more other devices within the database system via, for example, a high-speed network or communications interface.

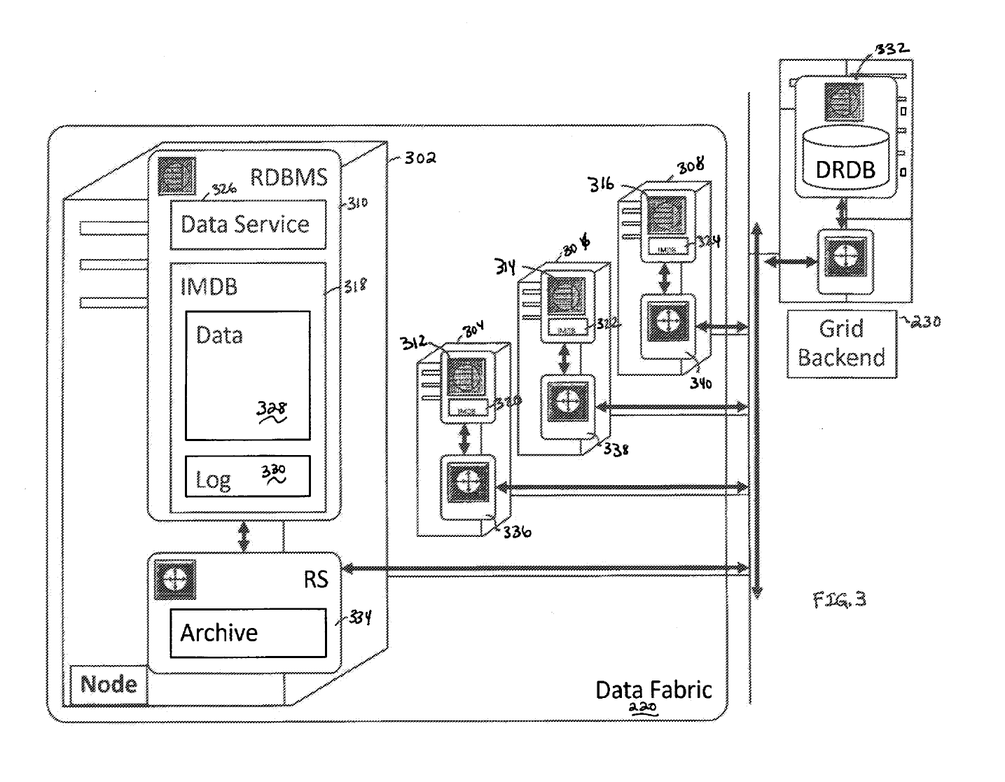

Referring now to FIG. 3, a block diagram of a data fabric 220 is illustrated depicting an example having four cache nodes 302, 304, 306, and 308. Although only four cache nodes are shown, more or fewer cache nodes may be utilized. As shown, each cache node of the data fabric 220 is communicatively coupled to the grid backend 230.

In an embodiment, the processing of query transactions via the cache nodes 302, 304, 306, and 308 occurs by the RDBMS functionality (e.g., ASE) of the each cache node, 310, 312, 314, and 316. IMDBs 318, 320, 322, 324, respectively, provide the database cache structure of each cache node implemented using one or more memory devices. An example of a suitable basis for providing an IMDB in an ASE embodiment is described in co-pending U.S. patent application Ser. No. 12/726,063, entitled “In-Memory Database Support”, assigned to the assignee of the present invention and incorporated herein by reference.

In an embodiment, cache nodes 302, 304, 306, 308 contain backend data cached from grid backend 230 at startup. All or a portion of the backend data stored in the disk resident database (DRDB) 332 of grid backend 230 may be copied initially to data fabric 220 at startup. In another embodiment, data fabric 220 can be started up without copying backend data from grid backend 230. For example, data fabric 220 may load the respective contents of cache nodes 302, 304, 306, 308 with pre-configured template files. Such template files may contain relevant enterprise data and be stored at, for example, any storage device within the database system accessible by data fabric 220. A person skilled in the relevant art given this description would appreciate the format and contents of such a template file.

Although shown as a component of data grid 200 in FIG. 2, it should be noted that grid backend 230 could be an optional component for data grid 200, according to an embodiment. Thus, the processing of data within data grid 200 (and data fabric 220) may not depend on the presence of grid backend 230. Accordingly, grid backend 230 can be connected and disconnected to and from data grid 200 as may be necessary for given application. For example, cache nodes 302, 304, 306, 308 may be implemented using volatile memory, and data fabric 220 may be configured to start without any initial backend data or store only temporary or transient data that does not need to be stored for later use. Further, if cached data stored at data fabric 220 needs to be persisted at shutdown, data fabric 220 may be configured to automatically save its contents to another persistent or non-persistent storage location. Such storage location may be, for example, a disk-based storage device or another backend database communicatively coupled to data grid 200 in the database system.

Alternatively, if data fabric 220 holds only transient data, it may be simply shut down without requiring the presence of a backend. It would be apparent to a person skilled in the relevant art given this description that such transient data is commonly used in high performance computing (HPC) type applications. It would also be apparent to a person skilled in the relevant art given this description that grid application 210 can include such HPC-type applications, but are not limited thereto.

In yet another embodiment, the data loaded into the cache nodes of data fabric 220 may be from grid applications 210 (FIG. 2). For example, grid applications 210 may connect to cache nodes 302, 304, 306, 308 to store and manage data directly therein. Such application data may be coherent across cache nodes 302, 304, 306, 308 without having any corresponding backend data or data local to a particular cache node within data fabric 220.

A person skilled in the relevant art would appreciate that data grid 200 may employ one or more data services 326 of a node that facilitate transaction processing between grid applications 210 and data grid 200, where each IMDB also includes a data storage portion 328 and a log storage portion 330 to support the transaction processing by the node. In an embodiment, the data services 326 include data access services (DAS) and data discovery services (DDS), where DAS refers to a data grid-oriented directory service, which identifies the connection node in terms of the data access needs, and DDS refers to a set of maps, which associate a data access with the node where it may be executed, as described in further detail herein below.

Also included are replication services, represented as RS 334, 336, 338, 340, which in an exemplary ASE environment comprises Replication Server from Sybase, Inc. of Dublin, Calif., in each node and provides asynchronous replication capabilities. In an embodiment, all writes to be replicated to other nodes in the clustered cache are captured in-memory and made available over the network.

In an embodiment, cache nodes 302, 304, 306, 308 of data fabric 220 may be associated with two different types of databases: a fabric database (Fab-DB) or a node database (Node-DB). A Fab-DB is global to data fabric 220 and data consistency is automatically maintained across cache nodes 302, 304, 306, 308 in accordance with an embodiment of the invention. It is redundantly stored for high-availability (HA) and scalability on several associated read-only (RO) nodes. In contrast, a Node-DB is local to a cache node and it may or may not be present at other cache nodes. No data consistency is maintained across the nodes for a Node-DB database. In an example, all system-specific databases are Node-DBs, and all cached user databases are Fab-DBs. A person skilled in the relevant art would appreciate that these designations are provided for illustrative purposes and embodiments are not limited thereto. In a further embodiment, a Fab-DB can have any of three levels of granularity: database granularity, table granularity, or partition granularity.

1. Database Granularity Data Fabric

In an example, a database from grid backend 230 (e.g., backend database 332) may be entirely cached as a Fab-DB in data fabric 220 for database granularity. Identical replicas of the Fab-DB are cached on cache nodes 302, 304, 306, 308. One node is designated as the read-write (RW) owner where data may be both read and written. The other nodes would accordingly hold read-only (RO) copies of the database. The applications are classified either as RW applications or as RO applications. All instances of all RW applications are connected to the RW node. The connections of all RO application instances are randomly distributed across all nodes. Further, any data modifications are asynchronously propagated from the RW owner to the RO nodes, in accordance with embodiments. With this asynchronous propagation, the performance of the writes done by the grid application incur no negative performance impact, i.e., there is no waiting for synchronization of data to complete on all other nodes, as would be the case in two-phased commit (2PC) architectures. There is also no disk I/O impact or contention found in traditional disk-based architectures with the in-memory design of the databases.

A DB-granularity fabric can contain one or several Fab-DBs. Further, a backend Fab-DB can be cached in one or several DB-granularity fabrics. When cached in more than one fabric, the RW-ownership stays at the backend. When cached in a single fabric, the RW ownership together with all corresponding RW application connections may be migrated, such as by a DBA, to any node of the fabric. In a maximal layout, for example, a node may own all backend user database Fab-DB, behaving thus just like the backend, but with IMDB performance and HA. Thus, a DB-Fabric layout offers straightforward application compatibility and excellent RO application scale-out. It also offers extreme IMDB performance with HA and DB-granularity scale-out to the RW applications, since several backend DBs may have their corresponding DB-granularity data fabrics owned by different nodes.

2. Table Granularity Data Fabric

In another example, one or more database tables from grid backend 230 (e.g., backend database 232) may be entirely cached as Fab-DB tables in data fabric 220 for table granularity. Identical replicas of the Fab-DB tables are cached on cache nodes 302, 304, 306, 308. One node is designated as the read-write (RW) owner where data may be both read and written. The other nodes would accordingly hold read-only (RO) copies of the tables. Further, similar to database granularity, any data modifications can be asynchronously propagated from the RW owner to the RO nodes, in accordance with embodiments.

3. Partition Granularity Data Fabric

In yet another example, portions of a backend database from grid backend 230 may be cached in data fabric 220 for a partition granularity. In an embodiment, the portions of the backend database can be distributed or sliced across cache nodes 302, 304, 306, 308 of data fabric 220. The slicing of the data from the backend database is done across the primary-foreign key inter-table relationship, so that any point query can be fully executed on any single cache node of data fabric 220. A set of tables that are connected by primary-foreign key constraints is referred to herein as a database tree schema (or simply “tree schema”). Each database tree schema has a root table and a set of child tables. A table is a child table if it has a foreign key referring to its parent. A tree schema can have several levels of child tables, making it a tree hierarchy.

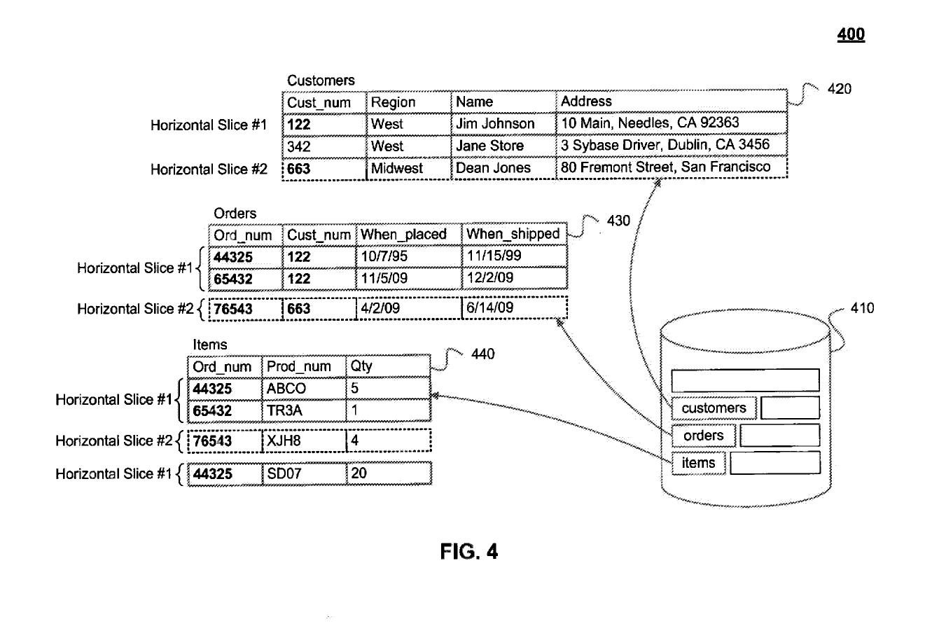

Referring now to FIG. 4, FIG. 4 illustrates an exemplary database tree schema 400, according to an embodiment. The example tree schema 400 includes a backend database 410, which may be any backend database within grid backend 230. Example backend database 410 includes a customers table 420, an order table 430, and an items table 440. A person skilled in the relevant art given this description would appreciate that the database and tables are provided for illustrative purposes only and embodiments are not limited thereto.

In the example illustrated in FIG. 4, customers table 420 is the root table of this hierarchy. It has a primary key on cust_num, which is the customer number. Orders table 430 has multiple orders per customer and has a foreign key constraint on the cust_num column. At the same time, it has a primary key of ord_num. For example, each order within orders table 430 can have several items and hence items table 440 is connected to orders table 430 on the foreign key constraint ord_num, while having a primary key of its own on prod_num. In this example, customers table 420, orders table 430, and items table 440 form tree schema 400 with customers table 420 at the root, orders table 430 a child of customers table 420 and items table 440 a child of orders table 430. When adopting such a tree schema into data grid 200, the child tables must include the primary key of the root table in its primary key, making it a composite key. For example, orders table 430 may need to have a primary key on (ord_num, cust_num).

Further, a subset of the backend database tables that form a tree schema can be sliced across a set of horizontal virtual partitions. Each such horizontal slice is stored on a cache node of data fabric 220. Such cache node (e.g., any one of cache nodes 302, 304, 306, 308) would have full and exclusive ownership of the data (both RW and RO). It should be noted that the corresponding backend data within backend database 410 may still be partitioned differently or un-partitioned. An advantage of the above-described data fabric layout is that it offers excellent relational data scale-out to grid applications 210. Additionally, some of the backend tables cached in a partitioned fabric, referred to herein as dimensions, are not part of any tree schema, and thus, they are not partitioned but are replicated to all fabric nodes. In an embodiment, the RW ownership of dimensions is defaulted to be on the backend, but the ownership of a dimension, which is cached in a single fabric, may be migrated to any node of that fabric.

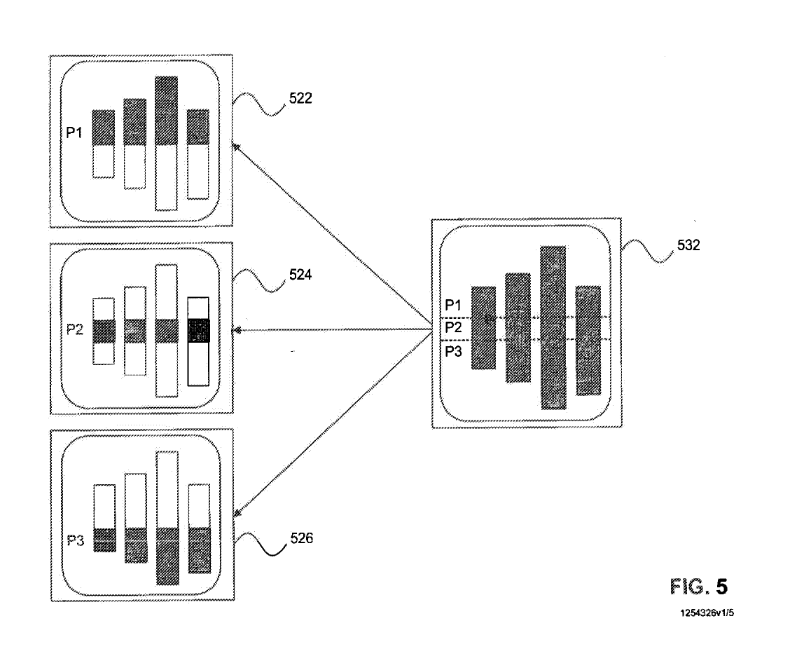

FIG. 5 is a diagram illustrating an example of splitting horizontal partitions (P1, P2, and P3) from a set of tables within backend database 532 across cache nodes 522, 524, and 526 within data fabric having partition granularity, according to an embodiment. Such data fabric may be implemented using, for example, data fabric 220 of FIG. 2 and cache nodes 522, 524, and 526 may be implemented using cache nodes 304, 306, and 308, described above. Backend database 532 may be implemented using, for example, backend database 232, described above. In the example illustrated in FIG. 5, four tables from backend database 532 belong to a tree schema (e.g., tree schema 400 of FIG. 4, described above) and are partitioned. It should be noted that each partition (P1, P2, and P3) may be stored on one or several cache nodes within the data fabric.

For a data fabric layout based on partition granularity, multiple slices are put into slice teams and multiple cache nodes are put into node sets, according to an embodiment. A person skilled in the relevant art given this description would appreciate that any number of well-known methods may be used to distribute slice teams on node sets. One example is to use a round-robin format for distributing RO and/or RW ownership of cache nodes based on multiple slice teams.

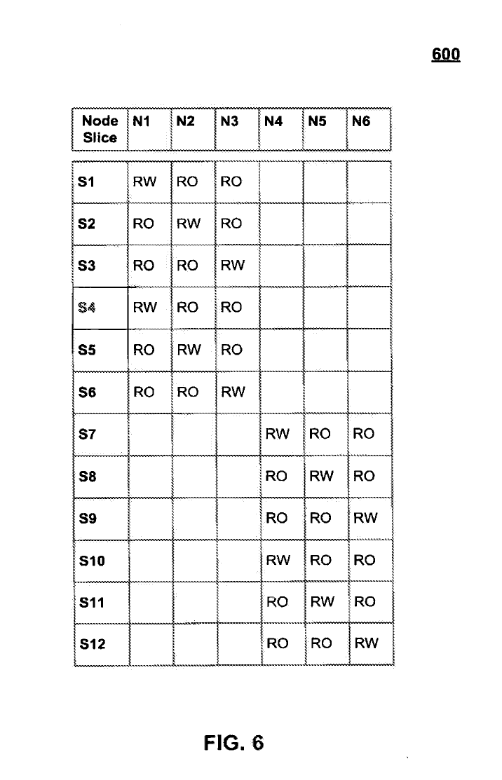

FIG. 6 is a table 600 illustrating an example of distributing ownership rights for multiple nodes based on round-robin slice teams, according to an embodiment. In the example shown in table 600, a data fabric layout with twelve slices on six cache nodes is used. Two slice teams and two sets of nodes are formed.

In an embodiment, minimally the type and the data to be cached need to be specified to define a fabric. For example, a command sequence such as follows creates a database granularity fabric called ‘Bharani_scoping’ that caches two databases, ‘drafts’, ‘discussion’, as IMDBs on cache nodes:

create fabric Bharani_scoping with

database drafts as IMDB, discussion as IMDB
fabric application “app_spec” type RW,

“app_bboard” type RW,
“app_wiki” type RO

ownership group spec_writing_closure database (drafts)

fabric application (“app_spec”),

spec_discussing_closure database (discussion)

fabric application (“app_bboard”)

Similarly, by way of example, a command sequence such as follows creates a 16-slice partition granularity fabric called ‘Customers’ having a default node set size of 2:

create fabric Customers with

table trading..customers partition by hash(cust_id)

16,

accounts foreign key(cust_id) references

customers(cust_id),

brokers

failover nodeset size 2
fabric application “app1” type RO

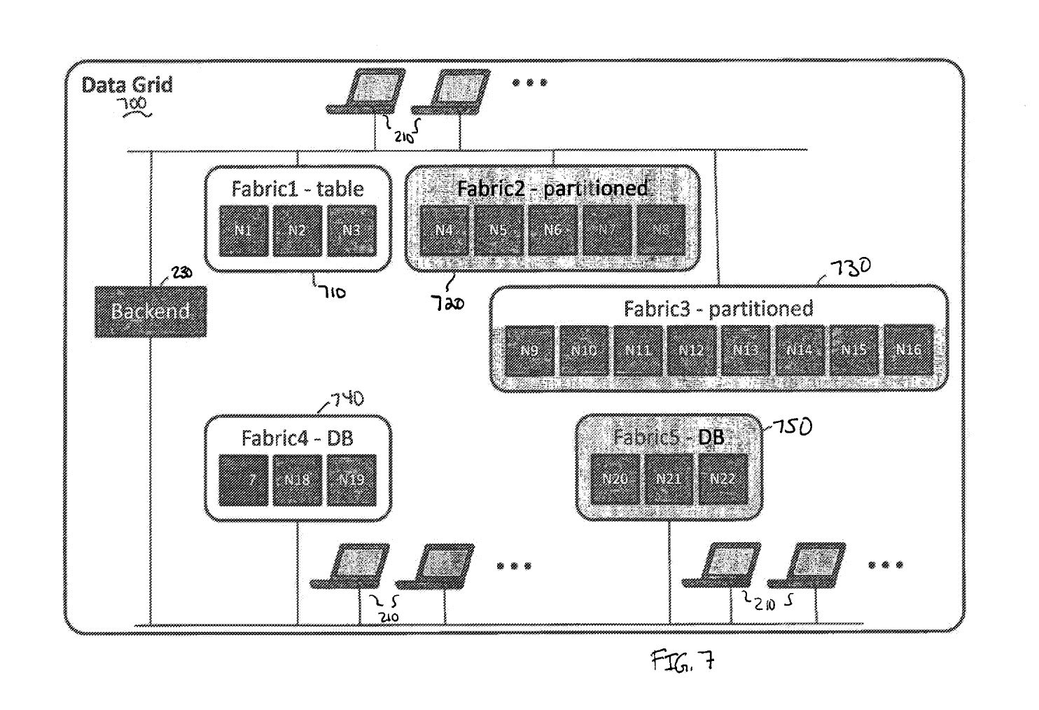

In an embodiment, system databases and temporary database cannot be part of a fabric definition. Further, the database(s) and table(s) used to define the fabric already exist, such as in the backend, with the tree schema tables used in the partition granularity fabric definition coming from the same user database. FIG. 7 illustrates an example data grid 700 created with several fabrics 710, 720, 730, 740, 750 among twenty-two nodes (N1 . . . N22).

A system database, e.g., sybgriddb, suitably stores the data grid layout, i.e., the definition of the data grid, the grid nodes, the fabrics of the grid and most information related to the management of the data grid. Acting like a master database to store the server information for a single RDBMS, the sybgriddb itself is a special FAB-DB owned by the backend RDBMS and existing on all grid cache nodes. In an embodiment, the grid layout includes the grid name and security policy, the fabric name and its status, (e.g., up (1) or down (0)), the number of grid nodes and their states, the RW owner nodes for database granularity fabrics, the tree schema tables and dimension tables for partition granularity fabrics, as well as the virtual partitioning condition for the tree schema and each slice's node set and owner node, a list of grid replication servers, and a list of FAB-DBs on each cache node.

In an embodiment, the sybgriddb also stores all DAS entries. The DAS involves establishing and maintaining connections to the required data and also the usage of setting correct configuration properties, so that applications should be and remain connected to a node that provides the functionality that the application needs. In most cases, the application's needs are described in terms of the data they need to efficiently access, but a functional description, like access to a specific node or set of nodes, is also possible.

The applications 210 specify at a logical level what data they need to access. In an embodiment, based on a traditional directory service capability that associates for an application a logical name with the physical description of a server (typically its IP address and port number), this single-node, server-oriented semantics are enhanced by associating a name with a data access. A DAS descriptor suitably specifies what data item the application will access and what kind of access it will make (RW vs. RO).

Thus, the DAS entries include the DAS name, network connection information, connection properties, service description, and server specific information. The DAS name identifies the DAS and acts as the key to all DAS information. When provided by the client library in the login record, it identifies what service the application expects. Thus, it can be used by applications as the sole value to pass to the library in order to identify the service that it wants to connect to and can be used to look up all other information required to provide a service to connecting client applications. Network connection information indicates the protocol and address information required to establish a connection to a system that provides the service, e.g., in the case of a TCP/IP connection, the hostname and port-number (“tcp host 5000” or “tcp host 5000 ssl”). There may be multiple addresses if multiple servers are able to provide the same service to the applications, as is well understood in the art. Connection properties indicate the properties required to be set to correctly establish the connection for this service, while the service description optionally provides a human readable description of the service. Server specific information describes internally the ‘what’ the DAS binds to.

In an embodiment, each node also has a DAS name pointing it, independently of what data it stores. For example, DAS names for each legal access to fabric data are predefined for each deployed fabric, e.g., for DB-granularity fabrics, the DAS names databases and the RW vs. RO access, and for partitioned fabrics, the DAS names either the fabric as a whole, or individual slices. DAS aliases can also be defined for any predefined DAS. Utilization of a DAS name allows connections only to that node and for bypassing automatic migration, which can be useful for certain situations, such as when a specific management command needs to be issued on a specific node.

As mentioned previously, the data services 326 of the nodes include DDS in addition to the DAS, with the DDS containing all metadata describing the data grid layout, e.g., the nodes and their state, the DB/table/partition-granularity fabrics and their associated nodes, node-sets and slice-teams, etc. With the DDS, each node knows whether any given data access is a legal local access or not to drive login redirection, connection migration and statement forwarding, as needed. An ATM Grid application, for instance, would use client-side DDS to identify the slice holding the data of the card owner and then would use that slice's DAS to connect to the appropriate node and have single-hop data access for the duration of that ATM card session (withdrawal, balance check, etc.).

Optionally, when also provided and enabled on a client-side locally, the applications may access the fabric with a zero-hop by interrogating the maps for the appropriate node. Thus, to the client application, DDS completes the DAS functionality by resolving partition key values to virtual partitions and offering the latest view of the data grid layout with the client-side DDS map automatically maintained by the data grid through asynchronous pushing of any layout change relevant to the data access.

Further included as part of the data services 326 in each fabric node is a Distributed Statement Processing (DSP) module, which uses the DDS information to classify, compile, and execute, either locally or remotely, SQL statements by simply checking that the application does only the data access requested by its connection's DAS. For instance, RW DML on a RO DAS connection or accessing data in a DB not described by the DAS is illegal.

It is recognized that massive RW DML, which updates data across all nodes of a fabric does not scale-out well under the ACID/2PC (two-phase commit) model, where the transaction has as many branches as fabric nodes, and its overhead (and probability to fail) is proportional with the number of nodes. By way of example, caching each customer's balance daily, e.g., to apply a daily fee when the policy depends on the total balance, would be a situation requiring massive RW DML. Accordingly, in an embodiment, a mapped stored procedure (SP) containing only decomposable statements is provided, such that the outcome of a map statement which succeeds on each node is the same as the execution of an SP on an SMP (symmetric multiprocessing) system holding all data. On each node, the local execution is an independent transaction. Mapped execution involves no 2PC and successfully scales out.

By way of example, the following represents a manner of creating an SP for mapping for the balance updating situation mentioned above:

create procedure update_balance
as
begin
-- refresh all up-to-date balance
update customer c
set c_balance =

```
( select sum(ca_cash)
  from account
  where
```

ca_c_id = c.c_id

```
)
+
( select sum(h_qty * lt_price)
  from holding, LastTrade
  where
```

h_c_id = c.c_id
and h_symb = lt_symb

)

end

With the SP created on the backend, it is naturally replicated to all nodes. Note that the update statement therein is decomposable and equivalent to a point update per customer. Then, it is mapped (i.e., executed concurrently) on all nodes, such as by invocation on the backend via a map statement. E.g., continuing the above example,
update the balance on all nodes
map update_balance on fabric Customers

This results in the concurrent and independent execution of update_balance on all nodes of the fabric Customers, so that on each node, the balance of all customers stored therein is updated.

The mapped execution of an SP returns no data. Thus, there is no no reduce phase for data. The map statement does reduce back, however, the state of the mapped execution on each node. System tables on the backend, e.g., sybmap and sybmapreduce, suitably contain the updated state of the mapped execution, i.e., in-progress/success/failure per node. In an embodiment, an application is responsible for retrying the mapped SP on nodes where the execution has failed and for enforcing the correct semantics also in case of failure.

Inherent in the use of IMDB for the clustered cache of the data grid, a single

IMDB failure exposes possible loss of data. Although that loss is limited to the last set of transactions that might have been committed in the IMDB but not yet distributed over the network to the other nodes in the clustered cache at the time of the IMDB failure, to support those applications where such transaction loss would not be recoverable, the data fabric includes a ‘Zero Transaction Loss’ (ZXL) configuration option. Under the ZXL configuration, each RW node in the fabric has its IMDB transaction log ‘mirrored’ synchronously with transaction commits across the network to another in-memory process on a different node, e.g., a ‘ZXL peer’. In event of RW-node crash, the mirror node uses these logs to prepare a new RW-node for the data-item by applying from the mirror log the data changes of the transactions missed by asynchronous replication.

Thus, writes of transaction commits to the RW node's transaction log requires successful synchronous writes to the ‘mirrored’ transaction log as well. In this way, the synchronous writes of all committed transactions for a given RW node are guaranteed to be available on the ZXL-peer should the RW node or its local hardware fail. As committed transactions are propagated to the asynchronous replicas, the log records describing them are not needed anymore and can be truncated off both the primary and the mirror log. At steady state, no other action than the mirror log synchronous write and asynchronous truncation is done. The ZXL overhead is thus minimal.

If a failure occurs, the transaction log mirror is used to complete distribution of the committed transactions to all other nodes storing a replica of data owned by the failing node (e.g., for partition-granularity, all nodes in the slice-team node-set, for DB-granularity, all nodes in the fabric), preventing the loss of transaction data from a single IMDB failure. In this manner, the ZXL operations provide ACID durability even in case of node failure, i.e., no committed transaction is lost even when all data in any given IMDB is fully lost.

In an embodiment, no intervention is required, as the processing of the ‘mirror’ transaction log is completed automatically through HA services, which monitor the health of the grid nodes and the communication links in the data fabric. In an embodiment, a heartbeat-based flat data grid-wide architecture provides suitable monitoring services, where all grid nodes are placed in a circular list, and each node monitors the next-in-line, independently of their belonging to a fabric [and slice-team] node-set. When monitoring detects a sequence of heartbeat failures, something has failed in the data grid, e.g., the monitored node, some network card, the network service, etc. Failure detection is done by the monitoring node through testing of the other nodes in the data grid to decide which component has failed. Once the monitored node is declared down, a failover service sets up a replica to offer access to the data owned by the failed node and triggers the ZXL service, if it is configured. At the end of the failover, any grid layout change is broadcast to the DDS on all grid nodes. Client failure detection continues normally with identifying the RW IMDB failure and redirecting application clients to an appropriate surviving node.

These HA services, together with the data grid architecture, which maintains replicas on K nodes, make data access available again on another node, even in the case of K−1 node failures. For DB-granularity fabrics, the failover domain is the whole fabric and K is given by the number of fabric nodes. For partitioned fabrics, the failover domain the slice-team node-set, and K is given by the size of the number of nodes in a node-set. In both cases, HA failover does not require massive data materialization, since the failover is done to a node that holds an asynchronous replica of the relevant data. Failover involves coordination, but is light data-wise, merely purging the replication queues and, if ZXL is active, replaying from another node the committed but not-yet-replicated transactions.

The data grid offers excellent scale-out to applications, which can be written or modified to embrace its programming paradigm, i.e., certain data organization and access rules. The paradigm includes that the data grid does no data shipping. Rather, data is always accessed on a node where it is available. For DB-granularity fabrics, the DAS guarantees local data access with RW DAS connection always established with the RW-owner node of the accessed DB and automatically migrated when the data grid layout changes, and with a RO DAS connection placed on any node of the fabric. For partitioned fabrics, statements are classified according to their data access and the tree schema tables and Dimensions of the fabrics caching the DB referred to by the DAS. Thus, the statements may be point statements, which access tree schema tables and can be executed with data in a single fabric slice, decomposable statements, which are equivalent to a set of point statements over the same fabric (i.e., which can be vertically decomposed), all-data statements, which are all other statements which access tree schema tables, or single-node statements, which access only Dimensions and can be executed on a single node.

In general, the basis of the scale-out is to stripe the partition-granularity fabric data across several nodes, so that any point query can be processed locally. Such a point query returns a data set that contains the persistent state of an entity manipulated by the application. The highest throughput scale-out is offered for applications, which observe the principle of locality: at any moment in time they do data access only for one entity. When a partitioned data fabric is saturated and becomes the scale-out bottleneck, new nodes can be added for distribution of fabric slices on the new nodes. In this manner, significant performance improvement can be achieved for applications embracing the data grid as described herein. Assistance in determining a layout of applications and data within a data grid in a database environment for use by application developers and database administrators to evaluate and design the data grid layout so as to optimize performance based on resource constraints, including, for example, hardware resources limits and types of data granularity, may be provided by advisory programming, such as described in co-pending U.S. patent application, Ser. No. ______ (Attorney Docket #1933.1500000), entitled “Data Grid Advisor”, filed on ______, and assigned to the assignee of the present invention, the details of which are incorporated herein by reference in their entirety.

Thus, as described herein, a data grid provides a distributed data cache database architecture, including one or more fabrics utilizing IMDB and replication technologies. Fabrics have data granularity types that define the data to be cached in the data grid. Once a fabric is started, it includes multiple inter-connected cache systems residing on different grid nodes. Each cache system either has access to all the databases locally or a slice of tables locally. Multiple copies of the same data have one writable copy with the remainder of the copies being read-only. Committed changes on the writable copy are asynchronously replicated to read-only copies from its owner node to read-only nodes. A RW application is automatically directed to the owner node, while RO applications can be processed on any node. A partitioned application can be distributed to its own node dedicated to the specific slice of data needed by the application. An extra node can be added to the fabric at any time to scale out more RO applications or to accommodate extra slices. High availability failover of the caching nodes is automatically handled by the fabric, including failing over an owner node to one of the read-only nodes. It would be apparent to a person skilled in the relevant art given this description that implementing data grid 200 within a database system would provide significant performance gains for processing transactions.

### III. Example Computer System Implementation

Aspects of the present invention shown in FIGS. 1-7, or any part(s) or function(s) thereof, may be implemented using hardware, software modules, firmware, tangible computer readable media having instructions stored thereon, or a combination thereof and may be implemented in one or more computer systems or other processing systems.

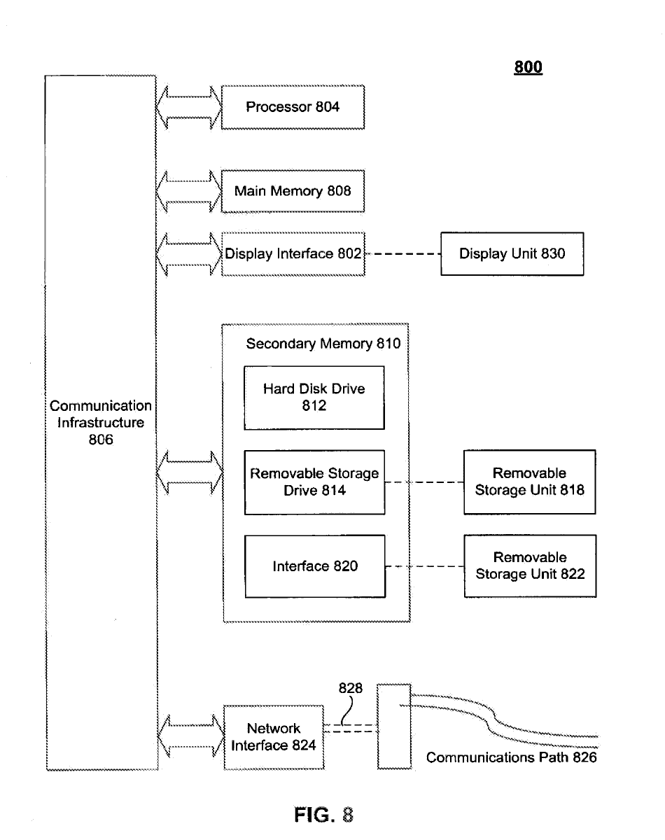

FIG. 8 illustrates an example computer system 800 in which embodiments of the present invention, or portions thereof, may by implemented as computer-readable code. For example, system 200 of FIG. 2, can be implemented in computer system 800 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-7.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 800. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. As will be appreciated by persons skilled in the relevant art, processor device 804 may also be a single processor in a multi-core/multiprocessor system, such system operating alone, or in a cluster of computing devices operating in a cluster or server farm. Processor device 804 is connected to a communication infrastructure 806, for example, a bus, message queue, network, or multi-core message-passing scheme.

Computer system 800 also includes a main memory 808, for example, random access memory (RAM), and may also include a secondary memory 810. Secondary memory 810 may include, for example, a hard disk drive 812, removable storage drive 814. Removable storage drive 814 may comprise a floppy disk drive, a magnetic tape drive, an optical disk drive, a flash memory, or the like. The removable storage drive 814 reads from and/or writes to a removable storage unit 818 in a well known manner. Removable storage unit 818 may comprise a floppy disk, magnetic tape, optical disk, etc. which is read by and written to by removable storage drive 814. As will be appreciated, by persons skilled in the relevant art, removable storage unit 818 includes a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card, or the like. Software and data transferred via communications interface 824 may be in the form of signals, which may be electronic, electromagnetic, optical, or other signals capable of being received by communications interface 824. These signals may be provided to communications interface 824 via a communications path 826. Communications path 826 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 818, removable storage unit 822, and a hard disk installed in hard disk drive 812. Computer program medium and computer usable medium may also refer to memories, such as main memory 808 and secondary memory 810, which may be memory semiconductors (e.g. DRAMs, etc.).

Computer programs (also called computer control logic) are stored in main memory 808 and/or secondary memory 810. Computer programs may also be received via communications interface 824. Such computer programs, when executed, enable computer system 800 to implement the present invention as discussed herein. In particular, the computer programs, when executed, enable processor device 804 to implement the processes of the present invention discussed above. Accordingly, such computer programs represent controllers of the computer system 800. Where the invention is implemented using software, the software may be stored in a computer program product and loaded into computer system 800 using removable storage drive 814, interface 820, and hard disk drive 812, or communications interface 824.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### IV. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. Further, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method comprising:
providing a scalable distribution of in-memory database (IMDB) system nodes organized as one or more data fabrics;
providing a plurality of data granularity types for storing data within the one or more data fabrics; and
managing database executions via the one or more data fabrics for a plurality of applications compatible with at least one data granularity type.

2. The method of claim 1 wherein managing database executions further comprises managing database transactions with ACID (Atomic Consistent Independent and Durable) consistency.

3. The method of claim 1 wherein managing database executions further comprises managing mapped execution of a stored procedure with eventual consistency.

4. The method of claim 1 further comprising managing read-write and read-only copies of the data based upon a number of fabrics storing the data and based upon the data granularity type.

5. The method of claim 4 further comprising asynchronously replicating committed changes on a read-write copy to read-only copies within a data fabric.

6. The method of claim 4 further comprising synchronously copying on at least a second node data changes of committed transactions of a first node.

7. The method of claim 1 further comprising supporting differing levels of application system scale-out in accordance with application compatibility with the plurality of data granularity types.

8. The method of claim 1 wherein the plurality of data granularity types further comprise a database granularity type, a table granularity type, and a partition granularity type.

9. The method of claim 8 further comprising supporting a high level of read-write scale-out for applications complying with data organization and access rules based upon the table and partition granularity types.

10. The method of claim 8 further comprising supporting a high level of read-only scale-out for applications complying with data organization and access rules based upon the database granularity type.

11. The method of claim 1 further comprising utilizing a disk-resident database to support data movement, including for at least one of persisting data from the one or more data fabrics, loading data into the one or more data fabrics, and rebalancing data within the one or more data fabrics.

12. The method of claim 1 farther comprising providing a data access service for connecting to a node offering requested access to a data item.

13. The method of claim 1 further comprising providing fail over from a read-write owner node to a read-only node within a fabric, the read-only node switching to behave as a read-write and owner node.

14. The method of claim 1 further comprising providing zero transaction loss through synchronous mirroring of transaction commits to another in-memory process on a peer node.

15. A system comprising:
at least one first in-memory database (IMDB) system node; and
at least one second in-memory database (IMDB) system node, the at least one first IMDB system node and the at least one second IMDB system node organized as one or more data fabrics for storing data according to one or more data granularity types and managing database executions for a plurality of applications compatible with at least one data granularity type.

16. The system of claim 15 further comprising a backend DRDB (disk-resident database) system coupled to the at least one first and at least one second IMBD system nodes and supporting data movement, including for at least one of persisting data from the one or more data fabrics, loading data into the one or more data fabrics, and rebalancing data within the one or more data fabrics.

17. The system of claim 15 wherein the at least one first IMDB system node and the at least one second IMDB system node further manage database executions by managing database transactions with ACID (Atomic Consistent Independent and Durable) consistency.

18. The system of claim 15 wherein the at least one first IMDB system node and the at least one second IMDB system node further manage database executions by managing mapped execution of a stored procedure with eventual consistency.

19. The system of claim 15 wherein the at least one first IMDB system node and the at least one second IMDB system node further asynchronously replicate committed changes on a read-write copy to read-only copies within a data fabric.

20. The system of claim 15 wherein the at least one first IMDB system node and the at least one second IMDB system node further synchronously copy on one node data changes of committed transactions of another node.

21. The system of claim 15 wherein the at least one first IMDB system node and the at least one second IMDB system node further provide fail over from a read-write owner node to a read-only node within a fabric, the read-only node switching to behave as a read-write and owner node.

22. A computer program product including a computer-readable medium having instructions stored thereon that, if executed by a computing device, cause the computing device to perform operations for a distributed data cache database architecture, the instructions comprising:
storing data according to a plurality of data granularity types within one or more data fabrics provided as a scalable distribution of in-memory database (IMDB) system nodes; and
managing database executions via the one or more data fabrics for a plurality of applications compatible with at least one data granularity type.
